(19) United States
(12) Patent Application Publication
(10) Pub. No.: US 2020/0032982 A1
(43) Pub. Date: Jan. 30, 2020

(54) BALLOON WHICH CAN BE ILLUMINATED FROM WITHIN, CAN BE FILLED WITH PROPELLANT GAS AND IS CAPABLE OF ASCENDING

(71) Applicant: Markus Bastian, Mainz (DE)

(72) Inventor: Markus Bastian, Mainz (DE)

(21) Appl. No.: 15/735,877

(22) PCT Filed: Jun. 9, 2016
(86) PCT No.: PCT/EP2016/063224

§ 371 Date: Dec. 12, 2017

(30) Foreign Application Priority Data
Jun. 12, 2015 (DE) 20 2015 103 077.0

(51) Int. Cl. F21V 3/02; F21S 9/02; A63H 27/10; G09F 21/10

(52) U.S. Cl. CPC F21V 3/023; F21S 9/02; F21Y 2115/10; G09F 21/10; A63H 27/10

(57) ABSTRACT

A balloon that can be illuminated from within, filled with propellant gas, and is capable of ascending has an interior space in which one or more light emitting diodes are located. The one or more light emitting diodes is or are connected or connectable via at least one cable or at least one contact with at least one energy source that is located outside of the interior space. The present disclosure also relates to a method of use of the balloon as a fan product or for illuminating restaurant gardens or parks, as an advertising medium, an advertising item, a lamp for interior and/or exterior areas, a signal balloon, a warning balloon, a signpost, an orientation aid, a navigation aid, an information sign, or a communication element.

### BACKGROUND

### Technical Field

The disclosure relates to a balloon, which can be illuminated from within, can be filled with propellant gas, and is capable of ascending, with a lower and an upper area when used for generic purposes and with an interior space, and in some cases, a giant balloon which can be illuminated from within and which is filled with propellant gas.

### Description of the Related Art

In Germany, giant balloons which are illuminated from within may only rise up to a height of 30 m. With such balloons, a logo can be shown in the sky that can be recognized from afar even at night. Balloons with the logo of a football club or in the form of a jersey could also be expedient for the mass market.

There are balloons available in which the light source is connected via a cable to an energy source on the ground. Such balloons require large quantities of expensive helium in order to bring the long cable up to the required height and keep it there.

Further, there are balloons which are illuminated with light emitting diodes (LEDs), in which the battery is located in the interior space of the balloon. This has the disadvantage that parts of the propellant gas escape when batteries are replaced. This principle is also described in U.S. Pre-Grant Publication No. 2012/0148765. Here, the battery is located behind the valve, i.e., in the area where the propellant gas is located.

In the publication WO 2001 083 067 and U.S. Pre-Grant Publication No. 2008/0084689, an external battery is included. In both documents, LEDs are arranged on the surface, however, or integrated into the surface of the balloon in order to radiate outwards. In contrast to the present disclosure, the interior space of the balloon is therefore not illuminated. This has disadvantages, since the balloon surface is not evenly illuminated, as is clearly presented in both publications.

U.S. Pre-Grant Publication No. 2009/0191787 does show an interior illumination, but in this case each LED is connected individually with a cable, which is then guided through a sealed point through the balloon sheath and is then connected on the external side with the battery. This is entirely unsuitable for the production of a giant balloon intended for use as an advertising device with, e.g., more than 50 LEDs.

DE 33 05 969 A1 relates to an illumination part for the interior illumination of inflatable items. The illumination facility is attached on the closure of the inflatable item. Via an electrical feedthrough in the closure cap, the light source, which is arranged at the end of a hollow rod in the interior of the inflatable item, is supplied with power. The arrangement is intended to enable a positioning of the light source in the hollow space of the inflatable item. However, there is a risk that the rigid hollow rod swings up when the inflatable item moves and hits the wall of said item. Advantageously, when the recommended halogen luminaires are used, damage to the walls may occur due to the high temperatures of these luminaires.

A similar situation arises with the illumination unit for inflatable structures as presented in DE 20 2008 001 551 U1. This consists of a transparent or translucent plastic tube, in which a circuit board with light emitting diode rows is arranged. The light emitting diode rows are arranged in such a manner that the light is emitted in different directions. The plastic tube is also a closure for the opening of the balloon. Here, too, a tipping over of the plastic tube is possible, and an even illumination can thus only be achieved with difficulty, and there is the risk of damage to the balloon.

There is accordingly a need to provide a low-cost option for producing such a balloon.

Further, there is a need to overcome the disadvantages of the prior art and to provide a balloon which can be illuminated from within, can be filled with propellant gas and is capable of ascending, which is as easy as possible to produce, guarantees the most even illumination possible, has a decreased risk of damage, and enables easy access to the voltage source of the illumination facility.

### BRIEF SUMMARY

Accordingly, the present disclosure provides a balloon which is be illuminated from within and is filled with propellant gas, or a giant balloon in the interior of which several LEDs are located which illuminate the interior space of the balloon or giant balloon, wherein the LEDs are electrically interconnected in the interior space of the balloon or giant balloon and are connected via a shared cable or contacts by way of a sealed point with an energy source which is located outside of the space filled with propellant gas, and is maintained at its height solely by the propellant gas.

### BRIEF DESCRIPTION OF THE SEVERAL VIEWS OF THE DRAWINGS

Further features and advantages of the present disclosure are included in the description below, in which embodiments of the present disclosure are explained with reference to schematic drawings, in which:

FIG. 1 shows a cross section through a giant balloon according to the present disclosure in a first embodiment,

FIG. 2 shows a further cross section through a giant balloon according to the present disclosure in a first embodiment,

FIG. 3 shows a cross section through a giant balloon according to the present disclosure in a second embodiment,

FIG. 4 shows a further cross section through a giant balloon according to the present disclosure in a second embodiment, and

FIG. 5 shows an embodiment of a balloon that can be illuminated from within, which can be filled with propellant gas, and which is capable of ascending.

### DETAILED DESCRIPTION

Features of a balloon according to the present disclosure advantageously include a light emitting diode (LED) illumination of the interior space with an energy supply via a battery or rechargeable battery which is attached outside of the balloon and which can be maintained at its height by the propellant gas.

The present disclosure in some embodiments comprises electrically interconnecting several LEDs in the interior space of the balloon and to then connect them via a cable or contacts with the battery on the outside. The present disclosure accordingly provides in one embodiment that the LEDs are connected via a cable or contacts with the battery or energy supply on the outside. Consequently, the previously-described disadvantages can be avoided.

The present disclosure thus provides a new-style and inventive combination of the features described, which are all necessary in order to build a low-cost, internally illuminated balloon or giant balloon.

In one advantageous embodiment of the balloon or giant balloon, the light source comprises or consists of an LED bar (strip with LEDs), an LED lamp and/or a mat with LEDs. Further, it can be provided that the LEDs are attached to the sheath of the balloon and radiate out into the interior space and thus illuminate the interior space and/or are allocated at a distance from the balloon sheath and thus illuminate the interior space. Accordingly, in a similar manner as with City Light Poster (CLP) advertising items known in the prior art, in a preferred embodiment according to the present disclosure, the LEDs can be arranged at a certain distance from the balloon sheath and thus illuminate the entire interior space of the balloon.

The present disclosure also provides a balloon or giant balloon that can be illuminated from within, can be filled with propellant gas and is capable of ascending, with a lower and an upper area when used for generic purposes, and with an interior space, wherein in the interior space, one or more light emitting diodes are located, which are designed and equipped to illuminate the interior space of the balloon, wherein the one or more light emitting diodes is or are connected or connectable via at least one first cable or at least one contact with at least one energy source, which is located outside of the interior space which can be filled or is filled with propellant gas, characterized in that the balloon is formed from one, two or more material strips or comprises said strips, which is or are interconnected along shared seams in such a manner as to be sealed against the propellant gas, that the one light emitting diode or several light emitting diodes is or are incorporated in sections in one or in several places into at least one provided shared seam of adjacent material strips, or that one, in some cases flexible, first connecting element is incorporated in sections or essentially completely in one or more places into at least one provided shared seam of adjacent material strips or adjacent material sections, wherein the one light emitting diode or the several light emitting diodes is or are connected or connectable with the first connecting element, or that the one light emitting diode or the several light emitting diodes is or are connected in sections in one or in several places with the inner wall of one or more material strips, or that the, in some cases flexible, first connecting element is connected in sections in one or more places with the inner wall of one or more material strips, wherein the one light emitting diode or the several light emitting diodes is or are connected or connectable with the first connecting element.

A balloon or giant balloon in the sense of the disclosure should be a hollow body which is delimited by walls. These walls generally feature an inner wall and an outer wall. The walls of a balloon can be designed as a single piece or comprise several wall sections. The balloon walls or the material strip that forms the balloon is advantageously light-permeable, e.g., transparent, translucent, or opaque. In the case of several material strips, one or more strips can also be light-impermeable, as long as at least one material strip is light-permeable. A balloon or giant balloon according to the present disclosure usually has an opening, in some cases a closable opening, for filling and emptying the balloon. The volume enclosed by the walls, the interior space, changes when the balloon is filled with a gas. A balloon emptied of gas usually has a smaller interior space volume than a filled balloon. In general, a volume increase in balloons can also be achieved through expansion of an elastic wall material. Naturally, for the balloon or giant balloon according to the present disclosure, wall materials are also feasible which are not expandable.

Balloons or giant balloons according to the present disclosure generally have upper and lower areas when used for generic purposes. These can often be easily recognized by the form or print on the balloon, since the aim is usually to present motifs and lettering upright. The opening for filling and emptying the balloon is often located in its lower area. Balloons filled with propellant gas experience uplift in the lower regions of the earth's atmosphere and ascend. In order to prevent them from flying away, they are generally affixed with attachment elements such as wires or cords, while larger balloons are also affixed with ropes or cables at suitable fixing points. These attachment elements are often connected to the balloon in its lower area. In this case, the uplift ensures that the balloon stands upright and the lower area points towards the ground, while the upper area points towards the sky.

Balloons or giant balloons according to the present disclosure or their walls can be designed as a single piece. A typical example of such an embodiment is the air balloon, as is popularly used, e.g., for children's birthday parties. However, there are also balloons or giant balloons corresponding to the present disclosure, the walls of which comprise or consist of several individual pieces. Frequently, two or more material strips are interconnected for the purpose in a propellant gas-tight manner. These material strips can comprise or consist of one or also several material layers, e.g., film laminates. The material strips are connected to each other depending on the material. When the material strips are connected, shared seams are formed. These seams can in principle have any breadth or expansion required, as long as this does not impair the propellant gas seal of the connection. A typical example of such a type of balloon is the so-called film balloon. The seams can, for example, be glued together or welded.

The seams can be designed in such a manner that a fastening or incorporation of the light emitting diode or light emitting diodes in the seam is possible. Thus, the light emitting diode or light emitting diodes can be affixed or incorporated directly or indirectly via connecting elements on one or more points in the seam.

In one embodiment, the balloon or giant balloon is a latex balloon. In a further embodiment, the balloon or giant balloon according to the present disclosure is a film balloon. According to the present disclosure, a film balloon is rather suitable. For this purpose, it can be advantageous when the material strips are film strips.

It has been shown that material strips with thicknesses in the micrometer range are in general suitable, for example with a thickness in the range of 5 to 100 μm, in some cases in the range of 10 to 50 μ or in the range of 10 to 30 μm.

In one advantageous embodiment, adjacent material strips, in some cases film strips, are connected via a seam, which is in some cases a weld seam or bond seam. The seam or seams can here be present in the interior space or outside the interior space. In some cases, at least one seam, and in some further cases essentially all seams, are outside the interior space.

It has been shown to be advantageous when the balloon or giant balloon is formed essentially from two material strips, in some cases film strips, or comprises said strips.

Alternatively, the balloon or giant balloon can be designed as a single piece. For example, a balloon according to the present disclosure can be provided by folding a single material strip and closing the open sides created as a result with seams. The advantage of the single-piece design is that only one single material strip must be provided in the manufacturing process. In the scope of the present disclosure, adjacent areas of a folded material strip are regarded as being adjacent material strips. Information regarding adjacent material strips thus also applies in general to the adjacent areas of a single folded material strip.

Further, it is advantageous when the several light emitting diodes in the interior space of the balloon are electrically interconnected or interconnectable. In this manner, only one single cable must be guided outwards from the interior space of the balloon.

It has also been shown to be advantageous when the balloon or giant balloon further comprises in at least one material strip, in some cases a film strip, an essentially propellant gas-tight penetration device for the first cable or first cables. Such a design separates the power supply of the light source spatially from the opening for filling and emptying the balloon. Here, essentially gas-tight means that no further propellant gas escapes through the penetration opening than from the usual closures of the opening for filling and emptying the balloon. It has surprisingly emerged as being advantageous when the power supply is not conducted in a seam, but rather when a penetration opening is present in a material strip, in some cases a film strip.

In one highly advantageous embodiment, the balloon or giant balloon comprises at least one valve, which is equipped and designed to fill the balloon with propellant gas, and a further valve equipped and designed to release the propellant gases from the interior space of the balloon. It can also be provided that the balloon or giant balloon comprises a valve equipped and designed for filling the balloon with propellant gas and for releasing the propellant gas from the interior space of the balloon. Such a valve or valves provides an easy-to-use opportunity for filling or emptying the balloon, while at the same time providing a closure of the opening or openings in the balloon walls required for this purpose.

For this purpose, it can be provided that the valve is equipped and designed to fill the balloon or giant balloon with propellant gas, and/or the valve equipped and designed to release the propellant gases from the interior of the balloon, and/or the valve equipped and designed to fill the balloon with propellant gas and to release the propellant gas from the interior of the balloon is essentially provided in a propellant gas-tight manner in a material strip, or is embedded in an essentially propellant gas-tight manner in a seam, and in some cases is provided in a material strip in an essentially propellant gas-tight manner.

In an advantageous embodiment, the material strip, in some cases the film strip, is single- or multi-layered, in some cases multi-layered. With multi-layered material strips, in some cases film strips, the different layers can fulfil different tasks. Thus, for example, the layer which forms the inner wall of the balloon or giant balloon can be designed and equipped to enable an essentially propellant gas-tight connection between two adjacent material strips, in some cases film strips, and/or to itself be essentially propellant gas-tight, consist of propellant gas-tight material or comprise such material. The layer which forms the outer wall of the balloon can for example be designed and equipped to bear a motif, a logo, lettering or another visual message, for example it can be suitable for being printed on. In the case of a single-layer material strip, the one layer can also assume all desired functions.

In a suitable embodiment, at least one material strip is light-permeable at least in sections. As a result, the light can shine out from within through the material strip or material strips. The balloon is visible from a distance and imprints or other features can be better recognized. Here, it can also be provided that the light-permeable material strips are printed or vaporized at least in sections with light-impermeable material, e.g., with metals. In this manner, high-contrast visual impressions can be achieved.

It can additionally be provided that one or more material strips or also individual layers of one or more material strips are dyed. In this manner, the colored appearance of the light emitting from the balloon can be altered. For this purpose, it can also be provided that colored LEDs are used.

In an advantageous manner, the material strip or material strips and/or at least one layer of the material strip or material strips comprises or comprise at least one plastic. Material strips made of polyamide or a polyester, in some cases PET, are particularly suitable. Blends of polyesters such as PET and polyamides can be used for propellant gas-tight material strips. Naturally, laminated systems can also be used.

In some embodiments, it can also be provided that the balloon has a control facility, which is designed and equipped to switch on and off several or all LEDs according to specified parameters. Thus, the balloon can for example be made to flash. If LEDs of different colors are present, the color of the light emitted from the balloon can be altered through the targeted switching on and off of different colors.

In one embodiment, the light emitting diode is or comprises a standard light emitting diode, a laser diode, an organic light emitting diode (OLED) or a light emitting diode with optical resonator (RC-LED). Due to their low weight, low power consumption, and low thermal development, LEDs are extremely suitable for the interior illumination of a balloon or giant balloon.

Precisely for even illumination, it has been shown to be advantageous when the multiple light emitting diodes are provided as an LED matrix, LED grid, LED panel, LED bar, LED disk, LED strip, and/or as a plurality of individual LEDs or a plurality of individual LED chips.

In some embodiments the so-called “chip-on-board” LEDs (COB LED) are suitable as LED chips. These are generally high capacity, so that a small number is already sufficient in order to illuminate the balloon evenly.

Here, it can be provided that the LED matrix, LED grid, LED panel, LED bar, the LED disk, the LED strip, the individual LED, the plurality of individual LEDs, the LED chip and/or the plurality of individual LED chips, such as when incorporated in sections in the upper area of the shared seam of adjacent material strips, has a section, in some cases a free end, which is incorporated in the lower area in the shared seam of adjacent material strips, or is connectable or connected to the inner wall of a material strip, in some cases a film strip, or of the penetration device, either directly or via the at least one first cable or via a, in some cases flexible, second connecting element. The light source in the form of multiple light emitting diodes is connected to the wall of the balloon on at least two points. The light source can thus be affixed centrally in the interior space of the balloon. The even illumination is facilitated and the risk of damage to the balloon by the light source is reduced.

Alternatively, it can be provided that the LED matrix, LED grid, LED panel, LED bar, LED strip, LED disk and/or the individual LEDs or LED chips, such as the LED chips, are affixed on the inner wall of the balloon, in some cases adhered, so that they can in some cases radiate their light inwards, and the light shines outwards through the opposite material strip.

It has been shown to be advantageous when the longitudinal extension of the LED matrix, the LED grid, the LED panel, the LED bar, the LED disk or the LED strip is in the direction from the upper area to the lower area equal to or less than the maximum vertical extension of the balloon or giant balloon from the lower area through to the connection of the LED matrix, the LED grid, the LED panel, the LED bar, the LED disk or the LED strip to the inner wall or through to the incorporation into the shared seam of the adjacent material strip in the upper area when the balloon is used for generic purposes.

In one suitable embodiment, the balloon or giant balloon according to the present disclosure comprises a container for holding at least one battery or at least one rechargeable battery outside the interior space. The power supply via a voltage source arranged on the balloon significantly increases the flexibility of its potential uses. A provision of plug sockets or other voltage sources close to the intended place of use is not absolutely necessary. A situation can thus also be avoided whereby a cable or other form of power supply must be guided from a holding point to the balloon. Such a suspended power supply can constitute a considerable risk. However, there are certainly usage scenarios in which such a power supply is suitable.

Here, it can be provided that the container is a bag which is connected or connectable to the balloon via a third connecting element, in some cases a cord or a wire.

Alternatively, it has been shown to be advantageous when the container is formed from sections of a first material strip and a second material strip which overlap each other, which respectively lie beyond those material strip sections that form the interior space of the balloon, wherein the overlapping sections, in some cases on the periphery, are interconnected, in particular bonded or welded to form at least one hollow space.

Further, it can be provided that at least one of the overlapping sections that forms the container, in some cases only one of the overlapping sections that forms the container, has one, in some cases reversibly closable, opening, which is equipped and designed for the holding and/or removal of at least one battery or at least one rechargeable battery, in some cases adjacent to the interior space.

It is also advantageous when the balloon or giant balloon according to the present disclosure further comprises at least one battery provided in the container and/or at least one rechargeable battery provided in the container.

One advantageous embodiment further comprises an electrically conductive second cable, which is connected or connectable to the first cable or to the contact, in some cases on or adjacent to the propellant gas-tight penetration device. Via this cable, the voltage source can be connected to the first cable or the contact in an electrically-conductive manner and the light source can be supplied with electrical power.

Additionally, it has been shown to be practical when the balloon comprises a third connecting element, in some cases a string, a strip or a bridge, which is connected or connectable outside of the interior space to the lower area of the balloon or to the container. This third connecting element can serve to hold the balloon at a desired height or in a desired place.

In one embodiment, it is provided that the balloon comprises a third cable, which is designed and equipped to create an electrically-conductive connection between a voltage source and the second cable and/or the first cable and/or the contact, and wherein the third cable is designed and equipped to serve as a third connecting element.

The present disclosure further includes the use of a balloon or giant balloon according to the disclosure as a fan product or for illuminating restaurant gardens or parks, as an advertising medium, advertising item, lamp for interior and/or exterior areas, a signal balloon, a warning balloon, a signpost, an orientation aid, a navigation aid, an information sign, or communication element.

Two advantageous embodiments will now be described with regard to the realization of the features.

The first embodiment provides a giant balloon as shown in FIG. 1 and FIG. 2 in cross section.

In the interior, the balloon comprises or consists of an LED strip (3) which is connected to the balloon sheath (1). An LED strip (3) is a flexible strip with several LEDs (4) which are electrically interconnected. As a result, the entire interior space of the balloon is illuminated.

The LED strip is connected to an electric cable which runs through a sealed point (5) onto the outer side of the balloon. Due to the fact that the LEDs are electrically interconnected on the strip, only one sealed point is required for connection to the energy source.

On the outer side of the balloon is a bag (6) connected to the balloon sheath. The bag serves to hold the battery or rechargeable battery or a battery/rechargeable battery housing or a battery/rechargeable battery adapter (2). The electric cable runs from the sealed point (5) into the bag (6) to the energy source (2).

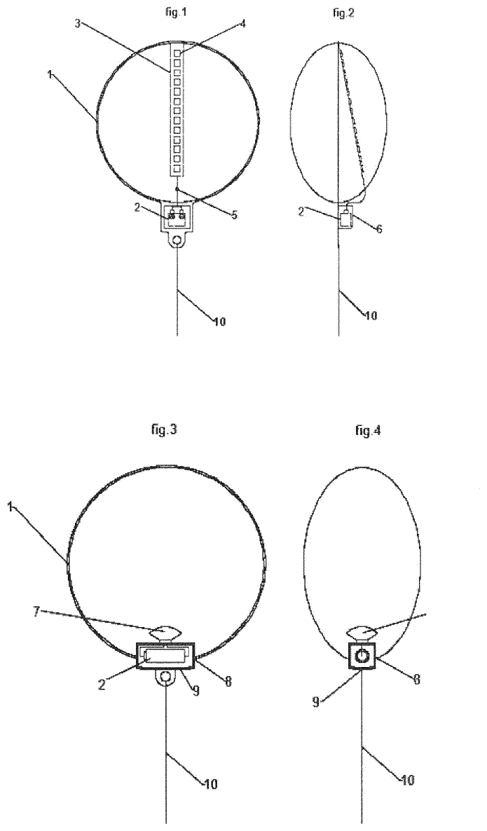

The second embodiment provides a giant balloon as shown in FIG. 3 and FIG. 4 in cross section.

The balloon sheath (1) is connected to a housing (8), in the interior space of which the battery or rechargeable battery is located. On the outer side of the housing pointing to the interior space of the balloon, an LED lamp (7) is connected.

Via the LED lamp, multiple LEDs are electrically interconnected in the interior space. Thus the LEDs are not attached on the balloon sheath and thus illuminate the interior space of the balloon. This is connected to the battery via electrical contacts. Further, on the battery housing (8) on the outer side, a lid (9) is located in order to replace the batteries.

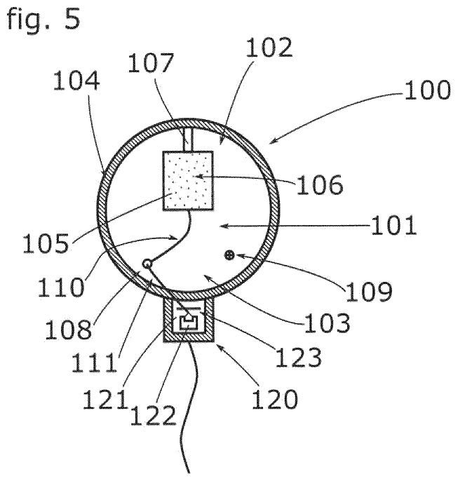

FIG. 5 shows an embodiment of a balloon (10) according to the present disclosure, which can be illuminated from within, filled with propellant gas and is capable of ascending. The interior space (101) of the balloon (100) is enclosed by a sheath made of two material strips, which are interconnected along shared seams (104) in a propellant gas-tight manner. In the upper area (102) of the interior space (101), an LED mat (105) with a plurality of LEDs (106) is affixed via a connecting element (107) which is incorporated into the seam (104) that is present outside of the interior space (101). Via a first cable (110), the LED mat (105) is connected to a penetration device (108) which is arranged in the lower area (103) of the balloon (100). Also in the lower area (103) of the balloon (100), a valve (109) is arranged for filling and emptying the balloon. On the lower area (103) of the balloon (100), a container (120) is arranged which is also formed from two material strips (122), in the container interior space (121) of which a power storage device (122) is arranged in the form of a battery or a rechargeable battery. Through a, e.g., slit-shaped, opening (123), the power storage device (122) can be removed from the container (120) and replaced. A second cable (111) connects the penetration device (108), e.g., through this opening (123), with the power storage device (120) and thus provides the power supply to the LED mat (106).

The features of the present disclosure in the above description, in the claims, and in the drawings can be essential both individually and in any combination required for the realization of the present disclosure in its different embodiments.

The various embodiments described above can be combined to provide further embodiments. All of the U.S. patent application publications, foreign patents, and foreign patent applications referred to in this specification and/or listed in the Application Data Sheet are incorporated herein by reference, in their entirety. Aspects of the embodiments can be modified, if necessary to employ concepts of the various patents and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A balloon, which can be illuminated from within, can be filled with propellant gas, and is capable of ascending, with a lower and an upper area when used, and with an interior space,
wherein in the interior space, one or more light emitting diodes are located, which are designed and equipped to illuminate the interior space of the balloon,
wherein the one or more light emitting diodes is or are connected or connectable via at least one first cable or at least one contact with at least one energy source, which is located outside of the interior space which can be filled or is filled with propellant gas,
wherein the balloon is formed from one, two or more material strips or comprises said strips, which is or are interconnected along shared seams in such a manner as to be sealed against the propellant gas, that the one or more light emitting diodes is or are incorporated in sections in one or in several places into at least one provided shared seam of adjacent material strips, or
that one first connecting element is incorporated in sections or essentially completely in one or more places into at least one provided shared seam of adjacent material strips or adjacent material sections,
wherein the one or more light emitting diodes is or are connected or connectable with the first connecting element, or that the one or more light emitting diodes is or are connected in sections in one or in several places with the inner wall of one or more material strips, or
that the first connecting element is connected in sections in one or more places with the inner wall of one or more material strips, and
wherein the one or more light emitting diodes is or are connected or connectable with the first connecting element.

2. The balloon according to claim 1, wherein said balloon is a latex balloon or a film balloon.

3. The balloon according to claim 1, wherein the material strips are film strips.

4. The balloon according to claim 1, wherein the seam that connects the adjacent material strips is a weld seam or a bond seam.

5. The balloon according to claim 1, wherein the at least one seam or all seams are essentially outside the interior space.

6. The balloon according to claim 1, wherein said balloon is formed essentially from two material strips or comprises said strips.

7. The balloon according to claim 1, wherein the light emitting diodes in the interior space of the balloon are electrically interconnected or interconnectable.

8. The balloon according to claim 1, further comprising
in at least one material strip, an essentially propellant gas-tight penetration device for the first cable or first cables.

9. The balloon according to claim 1, further comprising
a valve equipped and designed to fill the balloon with propellant gas, and a valve equipped and designed to release the propellant gases from the interior space of the balloon, or
a valve equipped and designed for filling the balloon with propellant gas and for releasing the propellant gas from the interior space of the balloon.

10. The balloon according to claim 9, wherein the valve equipped and designed to fill the balloon with propellant gas and/or the valve equipped and designed to release the propellant gases from the interior of the balloon and/or the valve equipped and designed to fill the balloon with propellant gas and to release the propellant gas from the interior of the balloon is essentially provided in a propellant gas-tight manner in a material strip, or is embedded in an essentially propellant gas-tight manner in a seam, and is provided in a material strip in an essentially propellant gas-tight manner.

11. The balloon according to claim 1, wherein the material strip is single- or multi-layered.

12. The balloon according to claim 1, wherein the material strip or material strips is or are light-permeable at least in sections.

13. The balloon according to claim 1, wherein at least one of the light emitting diodes is or comprises a standard light emitting diode, a laser diode, an organic light emitting diode, a light emitting diode with optical resonator, an LED chip, or a chip-on-board LED.

14. The balloon according to claim 1, wherein the light emitting diodes are provided as an LED matrix, LED grid, LED panel, LED bar, LED strip, LED disk and/or as a plurality of individual LEDs, or a plurality of individual LED chips.

15. The balloon according to claim 14, wherein the LED matrix, LED grid, LED panel, LED bar, LED strip, the individual LED, the plurality of individual LEDs, the individual LED chip, and/or the plurality of individual LED chips has a section that is incorporated in the lower area in the shared seam of adjacent material strips, or is connectable or connected to the inner wall of a material strip or of the penetration device, either directly or via the at least one first cable or via a second connecting element.

16. The balloon according to claim 1, wherein the longitudinal extension of the LED matrix, the LED grid, the LED panel, the LED bar, the LED disk or the LED strip is in the direction from the upper area to the lower area equal to or less than the maximum vertical extension of the balloon from the lower area through to the connection of the LED matrix, the LED grid, the LED panel, the LED bar, the LED disk or the LED strip to the inner wall or through to the incorporation into the shared seam of the adjacent material strip in the upper area when the balloon is for the generic purpose.

17. The balloon according to claim 1, further comprising
a container for holding at least one battery or at least one rechargeable battery outside the interior space.

18. The balloon according to claim 17, wherein the container is a bag which is connected or connectable to the balloon via a third connecting element.

19. The balloon according to claim 17, wherein the container is formed from sections of a first material strip and a second material strip which overlap each other, which respectively lie beyond those material strip sections that form the interior space of the balloon, wherein the overlapping sections are interconnected to form at least one hollow space.

20. The balloon according to claim 19, wherein at least one of the overlapping sections that forms the container has opening that is equipped and designed for holding and/or removal of at least one battery or at least one rechargeable battery.

21. The balloon according to claim 17, further comprising
at least one battery provided in the container and/or at least one rechargeable battery provided in the container.

22. The balloon according to claim 1, further comprising
an electrically conductive second cable that is connected or connectable to the first cable or to the contact.

23. The balloon according to claim 1, further comprising
a third connecting element that is connected or connectable outside of the interior space to the lower area of the balloon or to the container.

24. The balloon according to claim 1, wherein the balloon comprises a third cable that is designed and equipped to create an electrically conductive connection between a voltage source and the second cable and/or the first cable and/or the contact, and wherein the third cable is designed and equipped to serve as a third connecting element.

25. A giant balloon, which is or can be illuminated from within, filled or fillable with propellant gas, in the interior space of which several LEDs are located which illuminate the interior space of the giant balloon, wherein the LEDs in the interior space of the giant balloon are electrically interconnected and are connected via a shared cable or contacts by way of a sealed point with an energy source that is located outside of the space filled with propellant gas, and is maintained at its height solely by the propellant gas.

26. A giant balloon that is or can be illuminated from within, filled or fillable with propellant gas according to claim 25, wherein said several LEDs consists of an LED (strip with LEDs), an LED lamp, and/or a mat with LEDs.

27. A giant balloon that is or can be illuminated from within, filled or fillable with propellant gas, according to claim 25, wherein the LEDs are connected on a sheath of the balloon, and radiate into the interior space and thus illuminate the interior space, and/or are located at a distance from the balloon sheath and thus illuminate the interior space.

28. The use of the balloon according to claim 1 as a fan product or for illuminating restaurant gardens or parks, as an advertising medium, advertising item, lamp for interior and/or exterior areas, a signal balloon, a warning balloon, a signpost, an orientation aid, a navigation aid, an information sign, or communication element.

29. The balloon according to claim 1, wherein the first connecting element is a flexible connecting element.

30. The balloon according to claim 15, wherein the plurality of individual LED chips, when incorporated in sections in the upper area of the shared seam of adjacent material strips, has a free end that is incorporated in the lower area in the shared seam of adjacent material strips.

31. The balloon according to claim 15, wherein the second connecting element is a flexible connecting element.

32. The balloon according to claim 18, wherein the third connecting element is a cord or a wire.

33. The balloon according to claim 20, wherein only one of the overlapping sections that forms the container has a reversibly closable opening, which is equipped and designed for the holding and/or removal of at least one battery or at least one rechargeable battery.

34. The balloon according to claim 22, wherein the electrically conductive second cable is connected or connectable to the first cable or to the contact on or adjacent to the propellant gas-tight penetration device.

35. The balloon according to claim 23, wherein the third connecting element is a string, strip, or bridge.
